(19) United States
(12) Patent Application Publication
(10) Pub. No.: US 2024/0246818 A1
(43) Pub. Date: Jul. 25, 2024

(54) METHOD FOR PRODUCING ALKALI SULFONYL IMIDE SALTS

(71) Applicant: SPECIALTY OPERATIONS FRANCE, Lyon (FR)

(72) Inventor: Etienne Schmitt, Soucieu-En-Jarrest (FR)

(73) Assignee: SPECIALTY OPERATIONS FRANCE, Lyon (FR)

(21) Appl. No.: 18/564,470

(22) PCT Filed: May 10, 2022
(86) PCT No.: PCT/EP2022/062660

§ 371 Date: Nov. 27, 2023

(30) Foreign Application Priority Data
May 26, 2021 (EP) 21305685.6

(51) Int. Cl. C01B 21/093

(52) U.S. Cl. CPC C01B 21/0935

(57) ABSTRACT

The present disclosure relates to a new method for producing alkali salt of bis(fluorosulfonyl)imide of high purity, as industrial scale, and with a reasonable cost when compared to the other available methods. Said method comprises the steps of reacting a bis(chlorosulfonyl)imide or a salt thereof with an onium chloride to produce an onium salt of bis(chlorosulfonyl)imide; reacting an onium salt of bis(chlorosulfonyl)imide with anhydrous hydrogen fluoride in at least one organic solvent to produce onium salt of bis(fluorosulfonyl)imide; and reacting the onium salt of bis(fluorosulfonyl)imide with an alkali salt to obtain alkali salt of bis(fluorosulfonyl)imide.

### CROSS-REFERENCE TO RELATED PATENT APPLICATIONS

This application claims priority filed on 26 May 2021 in Europe with Nr 21305685.6, the whole content of this application being incorporated herein by reference for all purposes.

### TECHNICAL FIELD

The present invention relates to a method for producing alkali salts of bis(fluorosulfonyl)imide. More specifically, the invention provides a new method for producing alkali salts of bis(fluorosulfonyl)imide which is economically feasible at industrial scale and which provides a high-purity product.

### BACKGROUND

Fluorosulfonylimide salts, in particular the lithium salt of bis(fluorosulfonyl)imide (LiFSI), are useful compounds for battery electrolytes. Different processes, reactants and intermediates leading to LiFSI have been described in the patent literature.

One of the known intermediates leading to LiFSI is ammonium bis(fluorosulfonyl)imide (NH₄FSI). Several patent documents notably describe the preparation of LiFSI, with a first step of fluorination of bis(chlorosulfonyl)imide (HCSI) with a fluorinating agent, followed by a second step of lithiation of NH₄FSI, leading then to the LiFSI product.

Notably, WO 2017/090877 A1 (CLS) describes a method for producing LiFSI comprising the steps of: (1) reacting bis(chlorosulfonyl)imide (HCSI) with a fluorinating reagent in a solvent, followed by treatment with an alkaline reagent, thereby producing NH₄FSI; and (2) reacting NH₄FSI with a lithium base.

According to this document, the NH₄FSI intermediate is obtained directly by the fluorination of CSIH with a fluorinating agent in a solvent, followed by a treatment with an alkaline reagent in order to precipitate the product.

An object of the present invention is to provide an alternative route to the preparation of onium salts of bis(fluorosulfonyl)imide (onium salts of FSI), notably NH₄FSI, with an additional step in comparison to the method described in WO 2017/090877 A1, such route presenting however the advantages that the intermediate onium salt of CSI, notably NH₄CSI, is of high purity, positively impacting the purity of the other intermediates and final products, as well as the efficiency of the overall process.

WO 2015/158979 A1 (Arkema) describes an alternative process for preparing a fluoro compound of formula (III) R₂—(SO₂)—NX—(SO₂)—F, including the NH₄FSI intermediate, said process comprising: (a) a first step for obtaining the chloro compound of formula (II) R₁—(SO₂)—NX—(SO₂)—Cl, this first step comprising the reaction of the sulfamide of formula (I) R₀—(SO₂)—NH₂ with a sulfurous acid and a chlorinating agent; and (b) a second step for obtaining the fluoro compound of formula (III), this second step comprising the reaction of the chloro compound of formula (II) with anhydrous hydrofluoric acid HF in at least one organic solvent.

WO 2019/229361 A1 (Arkema) also describes a similar process for producing a lithium bis(fluorosulfonyl)imide salt F—(SO₂)—NLi—(SO₂)—F, involving a first step of reacting sulfamic acid HO—(SO₂)—NH₂ in order to produce bis(chlorosulfonyl)imide Cl—(SO₂)—NH—(SO₂)—Cl and a second step of fluorinating bis(chlorosulfonyl)imide Cl—(SO₂)—NH—(SO₂)—Cl with anhydrous HF, optionally in at least one organic solvent SO₁, said step being carried out in a reactor made of a material M3 that is resistant to corrosion, or in a reactor that contains a base layer made of a material M1 coated with a surface layer made of a material M2 that is resistant to corrosion.

WO 2020/099527 (Solvay SA) discloses a method for producing an alkali salt of bis(fluorosulfonyl)imide, comprising the steps of: a) reacting bis(chloro-sulfonyl)imide or salts thereof with ammonium fluoride to produce ammonium salt of bis(fluorosulfonyl)imide; b) crystallizing by adding at least one precipitation solvent and separating the ammonium salt of bis(fluorosulfonyl)imide; and c) reacting the crystallized ammonium salt of bis(fluorosulfonyl)imide with an alkali salt to obtain alkali salt of bis(fluorosulfonyl)imide. Preferably, ammonium used and ammonium bis(fluorosulfonyl)imide is obtained at the end of the process. As detailed in the description and showed in the examples, step a) is carried out in a solvent.

EP 2674395 (Nippon Soda Co., Ltd.) discloses the reaction of ammonium N-(chloro-sulfonyl)-N-(fluorosulfonyl)imide with hydrogen fluoride to obtain ammonium N,N-di(fluorosulfonyl)imide.

EP 3203570 (Nippon Shokubai Co., Ltd.) discloses a method producing an electrolyte solution material containing a fluorosulfonylimide salt and a solvent, characterized in decompressing and/or heating a solution containing the fluorosulfonylimide salt and the electrolyte solution solvent to volatilize a fluorosulfonylimide salt production solvent.

An object of the present invention is to provide an alternative route to the preparation of onium salts of bis(fluororosulfonyl)imide (onium salts of FSI, notably NH₄FSI), and then to the preparation of alkali salts of bis(fluorosulfonyl)imide (alkali salts of FSI, notably LiFSI), such route being implementable at industrial scale and providing high-purity bis(fluorosulfonyl)imide products. In particular, a crucial part of the method of the present invention (i.e, step a), the first step) is carried out in the presence of the molten reaction product, for example molten HCSI, acting to disperse the reactants, and in the absence of solvent (or in the presence of a very limited quantity of solvent). For the reason that the intermediate onium salt of CSI is prepared in the melt, in the absence of solvent, its purity is high as there are no longer any possible side-reaction between the molten reaction product (for example HCSI) and the solvent, positively impacting the purity of the following products, notably onium salt of FSI and alkali metal salt of FSI. Furthermore, such alternative route presents the additional advantages that the reaction by-products (for example HCl gas) can be valorised without any specific separation/purification step, as well as that the preparation step of onium salt of CSI presents an endothermic thermal balance (due to an important HCl gas evolution), which makes the step and the overall process safer, in comparison to the processes described in the prior art.

### DISCLOSURE OF THE INVENTION

In the present application:
the expression “comprised between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

A first object of the present invention is method for producing an alkali salt of bis(fluorosulfonyl)imide, comprising the following steps:
a) reacting a bis(chlorosulfonyl)imide (or salt thereof) with an onium chloride to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a);
b) reacting the onium salt of CSI with anhydrous hydrogen fluoride in at least one organic solvent to produce an onium salt of bis(fluorosulfonyl)imide (onium salt of FSI); and
c) reacting the onium salt of FSI with an alkali salt to obtain alkali salt of bis(fluorosulfonyl)imide (alkali salt of FSI).

The method of the present invention is advantageous for the main reason that the intermediate onium salt of CSI, notably NH₄CSI, presents a high purity which is due to its preparation process in the melt, and can therefore be fluorinated directly to form the onium salt of FSI, notably NH₄FSI, without formation of significant solid waste, in comparison to the NH₄F fluorination approach described in the prior art.

Step a) of the method according to the invention consists in reacting bis(chlorosulfonyl)imide (or salts thereof) with an onium chloride to produce an onium salt of CSI. This step a) is performed in the melt in the absence of solvents and diluents. More precisely, the method is carried out in molten salt of bis(chlorosulfonyl)imide (or salts thereof), for example molten HCSI, acting to disperse the reactants and allowing the reactants involved in step a) to meet and react. Importantly, step a) of the method of the present invention is a solvent-free step. In other words, no solvent/diluent, alternatively a very low amount of solvent/diluent, is added to the reaction mixture during the reaction of step a). This is advantageous because first, the step for removing the solvent adds to the complexity of the industrial process, as well as its overall cost. Secondly, the solvents typically need to be treated before being used in such process, as only anhydrous solvent (characterized by a residual amount of water in the ppm range) can actually be used; additionally, the inherent reactivity of bis(chlorosulfonyl)imide (or salts thereof) can cause undesired side-reactions in presence of a variety of solvents considered for such chemical step, thereby leading to the formation of unexpected solvent's side-products. Important efforts are usually required in the subsequent steps of the process in order to remove these impurities (amongst others) from the final alkali salt of bis(fluorosulfonyl)imide (alkali salt of FSI).

In the context of the present invention, the term “solvent” is intended to mean a compound which presents the following three cumulative properties of 1/being present from the beginning to the end of the reaction, possibly added during the process, 2/unchanged during the process, in other words non-reactive towards the involved reactants, and 3/having to be removed at the end of the process in case the reaction product is to be in its pure form. Examples of solvents falling within the scope of this definition are given below. For the sake of clarity, the molten bis(chlorosulfonyl)imide (or salt thereof) used in the process of the present invention does not fall under the definition of “solvent” above-mentioned.

According to one embodiment of the present invention, step a) of the method described herein is carried out or in the presence of a very low amount of solvent, that-is-to-say an amount of solvent less than 5 wt. %, based on the total weight of the reaction mixture involved in step a). Preferably, according to this embodiment, the amount of solvent is less than 4 wt. %, less than 3 wt. %, less than 2 wt. %, less than 1 wt. %, less than 0.5 wt. %, less than 0.1 wt. %, less than 0.01 wt. %, or less than 0.001 wt. % of solvent, based on the total weight of the reaction mixture involved in step a). The total weight of the reaction mixture is obtained by adding the weight of the reactants, as well as the weight of the molten bis(chlorosulfonyl)imide (or salt thereof).

Solvents that are typically used in such processes are well-known and extensively described in the literature. Such solvents may be aprotic, for example polar aprotic solvents, and may selected from the group consisting of:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide, and
cyano-, nitro-, chloro- or alkyl- substituted alkane or aromatic hydrocarbon, for instance acetonitrile, valeronitrile, adiponitrile, benzonitrile, nitromethane, nitrobenzene.

Typically, the organic solvent used to carry out such processes may be selected from the group consisting of ethyl acetate, isopropyl acetate, butyl acetate, ethylene carbonate, dimethyl carbonate, ethyl methyl carbonate, propylene carbonate, valeronitrile and acetonitrile, as for example in the literature described in the backgroup section.

According to step a), a quantity of bis(chlorosulfonyl)imide (or salt thereof), for example HCSI, is heated above its melting temperature Tm(I), before the addition of the reactants (or reactive entities), in order to be in a molten state (also called liquid state). The reactants, which can be in a powder form or in a liquid form, are then added into the reaction mixture and allowed to react in order to produce the corresponding onium salt of bis(chlorosulfonyl)imide (onium salt of CSI), for example NH₄CSI. This means that the quantity of such reaction product, i.e. bis(chlorosulfonyl)imide (or salt thereof) increases over the course of step a). In other words, the molten reaction product is used to provide a medium to disperse the reactants and allow them to meet and react. No solvent is therefore necessary to perform step a), according to the present invention. This is advantageous, as it significantly simplifies the overall production process since such solvent does not need to be removed after the reaction, in order to obtain a high-purity onium salt of CSI, for example a high purity NH₄CSI. It presents the additional advantage that no additional step is needed to remove the water for the solvent.

In step a), bis(chlorosulfonyl)imide (or salts thereof) is used as raw material. It may be represented by the formula:

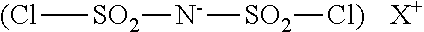

wherein X represents one from the group consisting of H, Li, Na, K and Cs.

According to a preferred embodiment, X represents H, which means that the raw material is bis(chlorosulfonyl)imide of formula:

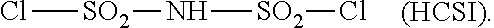

According to this preferred embodiment, step a) consists in reacting bis(chlorosulfonyl)imide (HCSI) with an onium chloride in absence of solvent to produce an onium salt of CSI. Even more preferably, the onium chloride used in this preferred step a) is ammonium chloride (NH₄Cl). According to this even more preferred embodiment, step a) consists in reacting HCSI with NH₄Cl to produce an ammonium salt of bis(chlorosulfonyl)imide (NH₄CSI). In this case, in absence of solvent, the reaction is such that HCl is released from the medium as an anhydrous gas, which is very advantageous. Optionally, the use of reduced pressure can be considered to accelerate the release of HCl during the addition of onium chloride or after complete addition of the onium chloride.

HCSI is possibly obtained from a commercial source, or it may be produced by a known method, for example:
by reacting chlorosulfonyl isocyanate ClSO₂NCO with chlorosulfonic acid ClSO₂OH;
by reacting cyanogen chloride CNCl with sulfuric anhydride SO₃, and with chlorosulfonic acid ClSO₂OH;
by reacting sulfamic acid NH₂SO₂OH with thionyl chloride SOCl₂ and with chlorosulfonic acid ClSO₂OH.

HCSI may be prepared either by the so-called isocyanate route or by the sulfamic route. In the latter case, the sulfamic acid employed can be optionally grinded and dried under vacuum, in order to decrease its water content and accelerate the kinetics of the transformation, hence reducing the reaction time significantly.

In some embodiments, the onium chloride used in step a), for example NH₄Cl, is such its moisture content is below 2,000 ppm, below 1,000 ppm, below 500 ppm, below 100 ppm, below 50 ppm or even below 10 ppm.

In another embodiment, step a) consists in reacting a salt of bis(chlorosulfonyl)imide (Cl—SO₂—N⁻—SO₂—Cl) X⁺ wherein X is selected from the group consisting of Li, Na, K and Cs, with ammonium chloride (NH₄Cl), in order to produce an ammonium salt of bis(chlorosulfonyl)imide (NH₄CSI).

Step b) of the method according to the invention consists in reacting the onium salt of CSI of step a) with anhydrous hydrogen fluoride (HF) in at least one organic solvent to produce onium salt of FSI.

According to the present invention, the hydrogen fluoride is anhydrous. Moisture content may be preferably below 5,000 ppm, below 1,000 ppm, below 500 ppm, below 100 ppm or even below 50 ppm.

The hydrogen fluoride HF is preferably introduced into the reaction medium in gaseous form. It may alternatively be introduced in the reaction in a liquid form.

The amount of hydrogen fluoride used in step b) is preferably comprised between 1 and 10 equivalents, more preferably between 1 and 7 equivalents, and even more preferably between 2 and 5 equivalents, per 1 mol of the bis(chlorosulfonyl)imide (or salt thereof).

Step b) is carried out in an organic solvent, which can be selected from the group consisting of:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl- substituted alkane or aromatic hydrocarbon, for instance acetonitrile, valeronitrile, adiponitrile, benzonitrile, nitromethane, nitrobenzene.

According to a preferred embodiment, the organic solvent is anhydrous. Moisture content may be preferably below 5,000 ppm, below 1,000 ppm, below 500 ppm, below 100 ppm, or even below 50 ppm.

According to the present invention, prior to step b) or in step b), the onium salt of CSI may be dissolved or suspended in the organic solvent prior to the addition of the anhydrous hydrogen fluoride.

In some embodiments, step b) is conducted at a temperature varying between 30° C. and the boiling point of the organic solvent. For example, step b) may be carried out at a temperature of between 30° C. and 100° C., preferably between 50° C. and 90° ° C., or between 70° C. and 80° C.

Step b) may be conducted at atmospheric pressure or can be conducted under reduced pressure. In some embodiments, step b) is conducted under reduced pressure. For example, step b) may be conducted at a pressure varying between 0 and 1013 mbar, or between 0 and 500 mbar, preferentially between 0 and 200 mbar, and more preferentially between 0 and 50 mbar.

In some embodiments, step b) consists in reacting the ammonium salt of CSI of step a) with anhydrous hydrogen fluoride in at least one organic solvent to produce ammonium salt of FSI.

When using anhydrous HF as fluorinating agent, the fluorination reaction leads to the formation of HCl, the majority of which may be degassed from the reaction medium (just like the excess HF), for example by sparging with a neutral gas (such as nitrogen, helium or argon). The sparged HF/HCl mixture can be further recycled.

The concentration of the onium salt of bis(fluorosulfonyl)imide within the reaction medium after step b) may be comprised between 10 wt. % and 95 wt. %, for example between 30 wt. % and 80 wt. %, or between 40 wt. % and 70 wt. % by weight.

After step b), but before step c), the method according to the present invention may comprise a step consisting in adding a basic compound to the reaction medium. This optional step corresponds to the neutralization of partially fluorinated onium salts before lithiation. The basic compound which can be used according to this optional step may be a solid, a pure liquid, an aqueous or organic solution or a gas. The basic compound may be selected from the group consisting of gaseous ammonia, ammonia water, amines, hydroxide, carbonates, phosphates, silicates, borates, formates, acetates, stearates, palmitates, propionates or oxalates of alkali or alkaline-earth metal. Among amines, any type of amines may be convenient, including, aliphatic amines (such as ethylamine, propylamine, butylamine, pentylamine, hexylamine, heptylamine, octylamine, dimethylamine, diethylamine, dipropylamine, dibutylamine, 2-ethylhexylamine, trimethylamine, triethylamine, tripropylamine and tributylamine), alkylenediamines (such as ethylenediamine, diethylenetriamine, triethylenetetramine, tetraethylenepentamine and pentaethylenehexamine), alkanolamines (such as monoethanolamine, diethanolamine, triethanolamine, monoisopropanolamine, diisopropanolamine and triisopropanolamine), alicyclic amines (such as cyclohexylamine and dicyclohexylamine), aromatic amines (such as benzylamine and metaxylenediamine), ethylene oxide adducts of these amines, formamidine, guanidine, amidine, and heterocyclic amines (such as diazabicycloundecene, diazabicyclononene, piperidine, morpholine, piperazine, pyrimidine, pyrrole, imidazole, imidazoline, triazole, thiazole, pyridine and indole). The basic compound is preferably gaseous ammonia or ammonia water.

The amount of basic compound added in this optional neutralization step is preferably of between 0.1 and 10 equivalents, preferably between 0.5 and 5 equivalents, more preferably between 0.5 and 3 equivalents, based on the quantity of onium salts to be neutralized.

During this optional neutralization step, the temperature may vary between 0° C. and 100° C., between 15° C. and 60° C. or between 20° C. and 40° C. The optional neutralization step may be carried out at the same temperature than step b).

After step b), but before step c), the method according to the present invention may comprise a step consisting in crystallizing the onium salt of FSI.

Such optional crystallization reaction may be carried out on the reaction medium as obtained after step b). Alternatively, the method may comprise a further step consisting in concentrating the onium salt of FSI within the reaction medium, typically by evaporating a part of the organic solvent of the reaction medium, by heating, by decreasing the pressure, or both. According to one embodiment, the concentration step may consists in a distillation of the solvent at a temperature comprised between 0° C. and 120° C., preferably between 5° C. and 80° C., more preferably between 10° C. and 70° C. The pressure may be adjusted depending on the nature of the solvent, typically between atmospheric pressure and 10-2 mbar, preferably between 1 mbar and 500 mbar, and more preferably between 5 mbar and 100 mbar. The distillation may be performed by any typical means known by the person skilled in the art on a continuous process mode or on a discontinuous/batch mode, for example a continuous batch mode solvent evaporation, a batch distillation, a continuous flow distillation of a short path, or a thin film evaporator.

The optional crystallization of the onium salt may be obtained by adding at least one precipitation solvent. At least one precipitation solvent is added to reaction mixture containing the salt. The precipitation solvent may preferably be selected among the organic solvent which are highly soluble within the organic solvent of the reaction mixture, and which are bad solvent for the onium salt of bis(fluorosulfonyl)imide. Said precipitation solvent may be selected from the group consisting of halogenated solvents like dichloromethane, dichloroethane, chloroform, and carbon tetrachloride; substituted aromatic hydrocarbon solvents like chlorobenzene, dichlorobenzene and toluene; and alkane solvents like cyclohexane, hexane, heptane, and Isopar™. Precipitation solvent may preferably be selected among dichloromethane and dichloroethane. The volume ratio between the precipitation solvent and the organic solvent of the reaction mixture may be comprised between 0.1 and 50, preferably between 0.2 and 20, more preferably between 0.5 and 15, and even more preferably between 1 and 10. Optionally, water may be added to the reaction mixture before adding the precipitation solvent, at a content which may be of between 0.01 wt. % and 20 wt. %, preferably between 0.1 wt. % and 10 wt. %, and more preferably between 1 wt. % and 5 wt. %, based on the total weight of the reaction mixture.

The temperature of the reaction mixture containing the salt may additionally be decreased to a value comprised between the solvent boiling point and −20° C., for example between 70° C. and −10° C., and for example between 30° C. and 0° C. During the reduction of the temperature, the pressure may preferably be kept constant. However, it is not excluded to reduce the pressure simultaneously. It may cause the evaporation of a part of the organic solvent of the reaction mixture. The pressure may be decreased to a value comprised between atmospheric pressure and 10-2 mbar, preferably between 1 mbar and 500 mbar, and more preferably between 5 mbar and 100 mbar.

According to one embodiment of the present invention, the method comprises a step of crystallization of the onium salt before step b) according to which the addition of the precipitating solvent is carried out without decreasing the temperature of the reaction mixture containing the salt. According to another embodiment, the method comprises a step of crystallization of the onium salt before step b) according to which the addition of the precipitating solvent is carried out with a decrease of the temperature of the reaction mixture containing the salt. The precipitation solvent is preferably added first, and the temperature is decreased afterwards. However, it is not excluded to proceed the other way, or to carry out the two actions simultaneously.

After step b), but before step c), the method according to the present invention may comprises a separation step. This optional separation step may be performed by any typical separation means known by the person skilled in the art, for example by filtration (for instance under pressure or under vacuum) or decantation. Mesh size of the filtration medium may be for example of 2 μm or below, of 0.45 μm or below, or of 0.22 μm or below. Separated product may be washed once or several times with appropriate solvent. The crystallization and separation steps may be carried out one time or may be repeated twice or more if necessary to improve the purity of the separated crystallized salt. Such intermediate separation step may be carried out after the optional neutralization step as described above, before step c).

After step b), but before step c), the method according to the present invention may comprise a step of drying the onium salt of FSI, for example a step of drying the ammonium salt of FSI. For example, the separated crystallized salt is dried to obtain a pure dry product. Drying step may be carried out by any means known by the person skilled in the art, typically under reduced pressure and/or by heating and/or with an inert gas flow, typically a nitrogen flow.

The onium salt of FSI obtained at the end of step b) of the method according to the present invention is characterized in that it presents a high purity, this onium salt being preferably an ammonium salt of bis(fluorosulfonyl)imide (NH₄FSI).

Step c) of the method according to the invention consists in reacting the onium salt of FSI obtained from step b) with an alkali salt to obtain alkali salt of FSI.

The onium salt of FSI obtained after step b) is then re-engaged into a further reaction. Indeed, the method according to the present invention comprises a step c) consisting in reacting the onium salt of FSI with an alkali salt in order to obtain an alkali salt of FSI.

When the alkali salt involves a lithium ion, step c) corresponds to a lithiation step. Step c) advantageously leads to a lithium salt of bis(fluorosulfonyl)imide (LiFSI).

The onium salt of FSI obtained after step b) may be used as such or solubilized in a solvent. According to one embodiment, the onium salt of FSI is solubilized in an organic solvent which may be selected from the aprotic organic solvents, preferably:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N, N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl- substituted alkane or aromatic hydrocarbon, for instance acetonitrile, valeronitrile, adiponitrile, benzonitrile, nitromethane, nitrobenzene.

According to a preferred embodiment, the solvent is selected from the group consisting of ethyl acetate, isopropyl acetate, butyl acetate, ethylene carbonate, dimethyl carbonate, ethyl methyl carbonate, propylene carbonate, valeronitrile and acetonitrile.

The alkali salt of FSI obtained after step c) is an alkali metal salt, preferably a lithium salt, a sodium salt or a potassium salt. Preferably, the alkali metal salt is a lithium salt, and the alkali metal salt of bis(fluorosulfonyl)imide obtained by the method according to the invention is a lithium salt of bis(fluorosulfonyl)imide (LiFSI).

Examples of alkali salts include alkali hydroxide, alkali hydroxide hydrate, alkali carbonate, alkali hydrogen carbonate, alkali chloride, alkali fluoride, alkoxide compounds, alkyl alkali compounds, alkali acetate, and alkali oxalate. Preferably, alkali hydroxide or alkali hydroxide hydrate is used in step c). If the alkali metal salt is a lithium salt, then the lithium salt may be selected from the group consisting of lithium hydroxide LiOH, lithium hydroxide hydrate LiOH.H₂O, lithium carbonate Li₂CO₃, lithium hydrogen carbonate LiHCO₃, lithium chloride LiCl, lithium fluoride LiF, alkoxide compounds such as CH₃OLi and EtOLi; alkyl lithium compounds such as EtLi, BuLi and t-BuLi, lithium acetate CH₃COOLi, and lithium oxalate Li₂C₂O₄. Preferably, lithium hydroxide LiOH or lithium hydroxide hydrate LiOH.H₂O is used in step c).

The alkali salt may be added in step c) as a solid, as a pure liquid or as an aqueous or organic solution.

The molar ratio of alkali salt to the onium salt of FSI used in step c) may vary between 0.2:1 and 10:1, between 0.5:1 and 5:1, or between 0.9:1 and 2:1.

Step c) may be carried out at a temperature of between 0° C. and 50° C., for example between 15° C. and 35° C., and preferably at about room temperature.

Step c) may be carried out at atmospheric pressure, or alternatively below or above atmospheric pressure, for instance between 5 mbar and 1.5 bar, preferably between 5 mbar and 100 mbar.

Further additional steps may be carried out after step c). For example, the method according to the present invention may comprise a separation step after step c). As described above with respect to the onium salt obtained after step b), this optional separation step may be performed by any typical separation means known by the person skilled in the art, for example by filtration (for instance under pressure or under vacuum) or decantation. As another example, the method according to the present invention may comprise an additional step of contacting the reaction medium with an inert gas stream to strip out ammonia.

When the alkali salt used in step (c) is an aqueous solution, the reaction medium may be a biphasic (aqueous/organic) solution. In this case, in order to recover the alkali salt of bis(fluorosulfonyl)imide, the method may comprise a phase separation step, during which the aqueous phase is removed and the alkali salt of bis(fluorosulfonyl)imide is recovered in the organic phase.

Additional steps may comprise filtration, concentration, extraction, recrystallization, purification by chromatography, drying and/or formulation.

All raw materials used in the method according to the invention, including solvents and reactants, may preferably show very high purity criteria. Preferably, their content of metal components such as Na, K, Ca, Mg, Fe, Cu, Cr, Ni, Zn, is below 10 ppm, more preferably below 5 ppm, or below 2 ppm.

Some of the steps or all steps of the method according to the invention are advantageously carried out in equipment capable of withstanding the corrosion of the reaction medium. For this purpose, materials are selected for the part in contact with the reaction medium that are corrosion-resistant, such as the alloys based on molybdenum, chromium, cobalt, iron, copper, manganese, titanium, zirconium, aluminum, carbon and tungsten, sold under the Hastelloy® brands or the alloys of nickel, chromium, iron and manganese to which copper and/or molybdenum are added, sold under the name Inconel® or Monel™, and more particularly the Hastelloy C276 or Inconel 600, 625 or 718 alloys. Stainless steels may also be selected, such as austenitic steels and more particularly the 304, 304L, 316 or 316L stainless steels. A steel having a nickel content of at most 22 wt. %, preferably of between 6 wt. % and 20 wt. % and more preferentially of between 8 wt. % and 14 wt. %, is used. The 304 and 304L steels have a nickel content that varies between 8 wt. % and 12 wt. %, and the 316 and 316L steels have a nickel content that varies between 10 wt. % and 14 wt. %. More particularly, 316L steels are chosen. Use may also be made of equipment consisting of or coated with a polymeric compound resistant to the corrosion of the reaction medium. Mention may in particular be made of materials such as PTFE (polytetrafluoroethylene or Teflon) or PFA (perfluoroalkyl resins). Glass equipment may also be used. It will not be outside the scope of the invention to use an equivalent material. As other materials capable of being suitable for being in contact with the reaction medium, mention may also be made of graphite derivatives. Materials for filtration have to be compatible with the medium used. Fluorinated polymers (PTFE, PFA), loaded fluorinated polymers (Viton™), as well as polyesters (PET), polyurethanes, polypropylene, polyethylene, cotton, and other compatible materials can be used.

A second object of the present invention is an alkali metal salt of bis(fluorosulfonyl)imide (alkali metal salt of FSI). Such salt may, for example, be obtained by the method of the present invention. The method described herein does involve in step b) hydrogen fluoride (HF) which can be very detrimental to the product, notably when the product is intended to be incorporated in a composition for a battery, such as an electrolyte. It is therefore very important to minimize as much as possible the remaining content of such hydrogen fluoride in the final product.

The inventors have been able to show that the HF content in the alkali metal salt of FSI obtained through the process of the present invention, can be reduced to less than 50 ppm, as determined by titration (or acido-basic titration), for example using an aqueous NaOH solution combined with a pH electrode and a potentiometer. The alkali metal salt of FSI of the present invention is therefore characterized in that its HF content is less than 50 ppm, less than 40 ppm, less than 30 ppm, less than 20 ppm or even less than 10 ppm.

The alkali salt of FSI of the present invention advantageously shows at least one of the following features (preferably all):
a purity of at least 98 wt. %, for example between 99 wt. % and 100 wt. % or between 99.50 and 100%, as determined by 19F NMR,
a solvent content of less than 20 wt. %, less than 10 wt. %, less than 1 wt. %, preferably between 0 wt. % and 1 wt. %, as determined by GC (alternatively headspace GC),
a moisture content of less than 500 ppm, less than 100 ppm, less than 50 ppm or even less than 20 ppm, as determined by Karl Fisher water titration, for example performed in a glovebox.

The alkali salt of FSI of the present invention advantageously shows at least one of the following features (preferably all):
a chloride (Cl−) content of below 100 ppm, preferably below 50 ppm, more preferably below 10 ppm, or more preferably below 2 ppm;
a fluoride (F−) content of below 100 ppm, preferably below 50 ppm, more preferably below 40 ppm, more preferably below 30 ppm, more preferably below 20 ppm; and
a sulfate (SO₄²⁻) content of below 100 ppm, preferably below 50 ppm, more preferably below 10 ppm, or more preferably below 2 ppm.

Fluoride and chloride contents may for example be measured by titration by argentometry using ion selective electrodes (or ISE). Sulfate content may alternatively be measured by ionic chromatography or by turbidimetry.

Preferably, it may show at least one of the following contents of metal elements (preferably all):
an iron (Fe) content of below 100 ppm, preferably below 50 ppm, more preferably below 10 ppm;
a chromium (Cr) content of below 100 ppm, preferably below 50 ppm, more preferably below 10 ppm;
a nickel (Ni) content of below 100 ppm, preferably below 50 ppm, more preferably below 10 ppm;
a zinc (Zn) content of below 100 ppm, preferably below 50 ppm, more preferably below 10 ppm;
a copper (Cu) content of below below 100 ppm, preferably below 50 ppm, more preferably below 10 ppm;
a copper (Cu) content of below below 100 ppm, preferably below 50 ppm, more preferably below 10 ppm;
a manganese (Mg) content of below 100 ppm, preferably below 50 ppm, more preferably below 10 ppm;
a sodium (Na) content of below 100 ppm, preferably below 50 ppm, more preferably below 10 ppm;
a potassium (K) content of below 100 ppm, preferably below 50 ppm, more preferably below 10 ppm;
a (Pb) content of below 100 ppm, preferably below 50 ppm, more preferably below 10 ppm.

Elemental impurity content may for example be measured by ICP-AES (inductively coupled plasma); more specifically, Na content can be measured by AAS (atomic absorption spectroscopy).

In some embodiments, the alkali salt of FSI of the present invention is an alkali metal salt, preferably a lithium salt of bis(fluorosulfonyl)imide, Li⁺ (FSO₂)₂N⁻ (LiFSI). The lithium salt of bis(fluorosulfonyl)imide may be characterized by the following impurity profile:
a purity of at least 99.90 wt. % and varying between 99.90 wt. % and 100 wt. %, as determined by 19F NMR, and
a moisture content of less than 50 ppm, as determined by Karl Fischer water titration.

A third object of the present invention is a method for producing an onium salt of bis(fluorosulfonyl)imide (FSI), comprising the steps of:
a) reacting a bis(chlorosulfonyl)imide (or salt thereof) with an onium chloride to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a); and
b) reacting the onium salt of CSI with anhydrous hydrogen fluoride in at least one organic solvent to produce an onium salt of bis(fluorosulfonyl)imide (onium salt of FSI).

According to this aspect of the present invention, an onium salt of bis(fluorosulfonyl)imide, for example NH₄FSI, is prepared and isolated. The method to produce such salt comprises at least two steps, namely step a) and b), which corresponds to step a) and step b) of the method described under the first object of the present invention. All the disclosure made with respect to these two steps applies to the method described under the third object of the present invention.

According to the present invention, the method for producing an onium salt of FSI, for example an ammonium salt of FSI, may comprise additional steps, as described above. For example, this method may comprise one or several of the following additional steps:
a step of adding a basic compound to the reaction medium, which corresponds to the neutralization or precipitation of the onium salt;
a step of crystallizing the onium salt of of bis(fluorosulfonyl)imide, or several steps of crystallization of the onium salts, for example under different conditions;
a step of separation, for example by filtration (for instance under pressure or under vacuum) or decantation;
a step of drying the onium salt of bis(fluorosulfonyl)imide, for example a step of drying the ammonium salt of bis(fluorosulfonyl)imide.

Preferably, the method for producing an onium salt of FSI of the present invention is a method for producing an ammonium salt of FSI, wherein in step a), the onium chloride is ammonium chloride NH₄Cl. In this case, the method of the present invention is a method for producing an ammonium salt of bis(fluorosulfonyl)imide (NH₄FSI), comprising the steps of:
a) reacting a bis(chlorosulfonyl)imide (or salt thereof) with an ammonium chloride to produce an ammonium salt of bis(chlorosulfonyl)imide (NH₄CSI), wherein the step is carried out in molten bis(chlorosulfonyl)imide (or salt thereof), in the absence of solvent or in the presence of a solvent less than 5 wt. % based on the total weight of the reaction mixture involved in step a); and
b) reacting the NH₄CSI with anhydrous hydrogen fluoride in at least one organic solvent to produce an onium salt of bis(fluorosulfonyl)imide (onium salt of FSI).

A fourth object of the present invention is the onium salt of bis(fluorosulfonyl)imide (FSI). Such salt may, for example, be obtained by the method of the present invention. The method described herein does involve in step b) hydrogen fluoride (HF) which can be very detrimental to the product, notably when the product is intended to be incorporated in a composition for a battery, such as an electrolyte. It is therefore very important to minimize as much as possible the remaining content of such hydrogen fluoride in the final product. The inventors have been able to show that the HF content in the onium salt of bis(fluorosulfonyl)imide obtained through the process of the present invention, can be reduced to less than 50 ppm, as determined by titration (or acido-basic titration) for example using an aqueous NaOH solution combined with a pH electrode and a potentiometer. The onium salt of bis(fluorosulfonyl)imide of the present invention is therefore characterized in that its HF content is less than 50 ppm, less than 40 ppm, less than 30 ppm, less than 20 ppm or even less than 10 ppm.

The onium salt of bis(fluorosulfonyl)imide of the present invention advantageously shows at least one of the following features (preferably all):
a purity of at least 98 wt. %, for example between 99 wt. % and 100 wt. % or between 99.50 and 100%, as determined by 19F NMR;
a solvent content of less than 20 wt. %, less than 10 wt. %, less than 1 wt. %, preferably between 0 wt. % and 1 wt. %, as determined by GC;
a moisture content of less than 500 ppm, less than 100 ppm, less than 50 ppm or even less than 20 ppm, as determined by Karl-Fischer water titration.

The onium salt of FSI of the present invention advantageously shows at least one of the following features (preferably all):
a chloride (Cl−) content of below 100 ppm, preferably below 50 ppm, more preferably below 10 ppm, or more preferably below 2 ppm;
a fluoride (F−) content of below 100 ppm, preferably below 50 ppm, more preferably below 40 ppm, more preferably below 30 ppm, more preferably below 20 ppm; and
a sulfate (SO₄²⁻) content of below 100 ppm, preferably below 50 ppm, more preferably below 10 ppm, or more preferably below 2 ppm.

Fluoride and chloride contents may be measured by means of titration by argentometry using ion selective electrodes (or ISE). Sulfate content may be measured by ionic chromatography or by turbidimetry.

Preferably, it may show at least one of the following contents of metal elements (preferably all):
an iron (Fe) content of below 100 ppm, preferably below 50 ppm, more preferably below 10 ppm;
a chromium (Cr) content of below 100 ppm, preferably below 50 ppm, more preferably below 10 ppm;
a nickel (Ni) content of below 100 ppm, preferably below 50 ppm, more preferably below 10 ppm;
a zinc (Zn) content of below 100 ppm, preferably below 50 ppm, more preferably below 10 ppm;
a copper (Cu) content of below below 100 ppm, preferably below 50 ppm, more preferably below 10 ppm;
a copper (Cu) content of below below 100 ppm, preferably below 50 ppm, more preferably below 10 ppm;
a manganese (Mg) content of below 100 ppm, preferably below 50 ppm, more preferably below 10 ppm;
a sodium (Na) content of below 100 ppm, preferably below 50 ppm, more preferably below 10 ppm;
a potassium (K) content of below 100 ppm, preferably below 50 ppm, more preferably below 10 ppm;
a (Pb) content of below 100 ppm, preferably below 50 ppm, more preferably below 10 ppm.

Elemental impurity content may be measured by ICP-AES (inductively coupled plasma); more specifically, Na content may be measured by AAS (atomic absorption spectroscopy)

In some embodiments, the onium salt of bis(fluorosulfonyl)imide of the present invention is a ammonium salt of bis(fluorosulfonyl)imide. The ammonium salt of bis(fluorosulfonyl)imide may be characterized by the following impurity profile:
a purity of at least 99.90 wt. % and varying between 99.90 wt. % and 100 wt. %, as determined by 19F NMR; and
a moisture content of less than 50 ppm, as determined by Karl-Fischer water titration.

A fifth aspect of the present invention is the use of the alkali salt of bis(fluorosulfonyl)imide, and preferably the lithium bis(fluorosulfonyl)imide, as described above, in electrolytes for batteries. This electrolyte can subsequently be used in the manufacture of batteries or battery cells by positioning it between a cathode and an anode, in a way known per se.

Should the disclosure of any patents, patent applications, and publications which are incorporated herein by reference conflict with the description of the present application to the extent that it may render a term unclear, the present description shall take precedence.

### EXAMPLES

The disclosure will be now described in more detail with reference to the following examples, whose purpose is merely illustrative and not intended to limit the scope of the disclosure.

### Example 1: Bis(Fluorosulfonyl)Imide Ammonium Salt Formation

### Step a)—Bis(Chlorosulfonyl)Imide Ammonium Salt Formation

A tri-necked 250 mL glass flask was equipped with a thermometer, a mechanically-stirred 4-blades shaft and a screw-type solid-addition head, and was connected to a KOH-scrubber via PTFE tubing. The system was flushed with Argon over 30 min before use. Bis(chlorosulfonyl)imide (52.6 g, 243 mmol) was melted in a glovebox and cannulated under Argon into the flask, then was pre-heated at about 50° C. Anhydrous ammonium chloride (13 g, 243 mmol) was loaded into the solid dosing screw-type glass apparatus, and was gradually added over 0.5 h under argon stripping and constant stirring. After complete addition, the slurry was heated at 60° C. under vigorous stirring during 1 h then at 75-80° C. over 2 h until no solid particles were left and gas evolution stopped. HCl was neutralized in the KOH-scrubber and chlorine content was recovered by ionic chromatography. Bis(chlorosulfonyl)imide ammonium salt was isolated (55.6 g, >99% yield) and was then dissolved in 1,4-dioxane (150 g) over 15 min at 25° C. under mechanical stirring. The resulting solution of bis(fluorosulfonyl)imide ammonium salt was used as such in the next step.

### Step b)—Bis(Fluorosulfonyl)Imide Ammonium Salt Formation: Fluorination of Bis(Chlorosulfonyl)Imide Ammonium Salt

The previously prepared mixture of bis(chlorosulfonyl)imide ammonium salt (55.6 g) in 1,4-dioxane (250 g) was introduced under Argon into an Hastelloy 0.5L autoclave equipped with a magnetically-coupled 4-blades stirring shaft and 4 baffles. Anhydrous HF (24 g, 5 eq) was gradually introduced at RT over 1 h under stirring into the system. The pressure increased over 6 h and stabilized. After 18 h, the excess HF was stripped with nitrogen over 12 h, the mixture was then filtered under Argon. Solid crude NH₄FSI (45.3 g, 95%) was dried at RT over 12 h and was analysed by 19F NMR, showing >99% purity.

### Example 2: Bis(Fluorosulfonyl)Imide Lithium Salt Formation

29.7 g of the dried solid obtained form Example 1 was solubilized in 300 g butyl acetate. 6.9 g of a 25 wt. % aqueous solution of LiOH.H₂O was added. The obtained biphasic mixture was stirred during 5 hours at room temperature, and then decanted. The organic phase was recovered and put into a thin film evaporator at 60° C. under reduced pressure (0.1 bar).

The purity of the obtained lithium bis(flurosulfonyl)imide (LiFSI) was above 99.99 wt. %, HF (residual acidity) content was below 5 ppm; chlorine and fluorine contents were below 20 ppm; metal elements contents were below 5 ppm, with no other impurities such as SO₄²⁻ and FSO₃ _{^{−}} detected (detection limit). LiFSI total yield was 90% (based on the NH₄FSI initially introduced).

1. A method for producing an onium salt of bis(fluorosulfonyl)imide, comprising the steps of:
a) reacting a bis(chlorosulfonyl)imide or salt thereof, with an onium chloride, to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a); and
b) reacting the onium salt of CSI with anhydrous hydrogen fluoride in at least one organic solvent to produce an onium salt of bis(fluorosulfonyl)imide (onium salt of FSI).

2. The method according to claim 1, wherein in step a), the onium chloride is ammonium chloride (NH₄Cl).

3. A method for producing an alkali salt of bis(fluorosulfonyl)imide, comprising the step of:
c) reacting the onium salt of FSI as obtained in claim 1, with an alkali salt, to obtain alkali salt of bis(fluorosulfonyl)imide (alkali salt of FSI).

4. The method according to claim 1, wherein step b) is conducted at a temperature varying between 30° ° C. and the boiling point of the organic solvent.

5. The method according to claim 1, wherein step b) is conducted under reduced pressure.

6. The method according to claim 1, wherein in step b), the onium salt of CSI is dissolved in the organic solvent prior to the addition of the anhydrous hydrogen fluoride.

7. The method according to claim 1, wherein in step b), the molar ratio of the onium salt of CSI to the anhydrous liquid/gas hydrogen fluoride ranges from 0.001:1 to 20:1.

8. The method according to claim 1, wherein in step b), the solvent is an anhydrous organic solvent with a moisture content below 5,000 ppm.

9. The method according to claim 2, wherein in step a), the ammonium chloride NH₄Cl is in powder form.

10. The method according to claim 1, wherein in step a), the molar ratio of the onium chloride to the bis(chlorosulfonyl)imide (or salt thereof) ranges from 0.001:1 to 20:1.

11. The method according to claim 3, wherein the alkali salt in step c) is selected from alkali metal hydroxides, alkali metal hydroxide hydrates, alkali metal carbonates, alkali metal hydrogen carbonates, alkali metal chlorides, alkali metal fluorides, alkali metal alkoxide compounds, alkyl alkali metal compounds, alkali metal acetates, and alkali metal oxalates.

12. An alkali metal salt of bis(fluorosulfonyl)imide (alkali metal salt of FSI) obtained by the method of claim 1, characterized in that its HF content is less than 50 ppm, as determined by titration.

13. A method comprising incorporating the alkali metal salt of FSI according to claim 1 in a battery electrolyte solution.

14. An onium salt of bis(fluorosulfonyl)imide (onium salt of FSI) obtained by the method of claim 1.

15. The onium salt of FSI of claim 14, having a HF content of less than 50 ppm, as determined by titration using an aqueous NaOH solution combined with a pH electrode and a potentiometer.
